(19) United States
(12) Patent Application Publication
(10) Pub. No.: US 2026/0276179 A1
(43) Pub. Date: Sep. 17, 2026

(54) BACKLIGHT MODULE AND DISPLAY DEVICE

(71) Applicant: RADIANT OPTO-ELECTRONICS CORPORATION, Kaohsiung City (TW)

(72) Inventors: You-Ting LIN, Kaohsiung City (TW); Han-Ciang JHONG, Kaohsiung City (TW); Hsien-Hsiang CHANG, Kaohsiung City (TW); Chiung-Hsien LAI, Kaohsiung City (TW)

(73) Assignee: RADIANT OPTO-ELECTRONICS CORPORATION, Kaohsiung City (TW)

(21) Appl. No.: 19/557,378

(22) Filed: Mar. 5, 2026

(30) Foreign Application Priority Data
Mar. 11, 2025 (CN) 202520415387.0

(51) Int. Cl. F21V 14/00; G06F 1/16

(52) U.S. Cl. CPC F21V 14/003; F21V 14/006; G06F 1/1656

(57) ABSTRACT

A backlight module comprises a bottom chassis, a light source unit, a middle frame, and a front chassis. The bottom chassis includes a plurality of sidewalls that collectively define a receiving space, with a gap formed between two adjacent sidewalls. The light source unit is disposed in the receiving space. The middle frame includes at least one positioning boss extending into the gap to restrict the position of the middle frame with respect to the bottom chassis. The front chassis covers the sidewalls and the at least one positioning boss. Through this configuration, the gap of the bottom chassis functions as an installation and positioning structure for the middle frame while suppressing light leakage from the backlight module.

### FIELD OF INVENTION

The present disclosure relates to a backlight module and, more specifically, to a backlight module that facilitates assembly and positional alignment of a middle frame while preventing light leakage, as well as to a display device incorporating the backlight module.

### BACKGROUND OF THE INVENTION

Referring to FIG. 1, components of a backlight module in a display panel are typically mounted to a metal bottom chassis of the backlight module. A bottom chassis 20A includes a base plate and sidewalls formed through a sheet-metal process involving stamping and bending. As a result of this manufacturing process, a gap 25A is produced between adjacent sidewalls. After the internal components of the backlight module are assembled, a front chassis 10A is mounted to the bottom chassis 20A. A concave-convex engagement structure is provided between the front chassis 10A and the sidewalls of the bottom chassis 20A, and the gap 25A between the adjacent sidewalls also serves to maintain elasticity of the sidewalls.

In the schematic illustration of the foregoing mounting structure, a light source unit 30A is mounted on the base plate of the bottom chassis 20A and is surrounded by a middle frame 40A. When light emitted from the light source unit 30A propagates toward the front chassis 10A, the light passes through an optical stack 50A, which may include optical films 51A and a diffusion plate 52A, as shown. However, after the light traverses the optical films 51A and related components, a portion of the light may exit toward edge surfaces thereof and subsequently project downward through the gap 25A between the sidewalls (as indicated by the dashed arrow in FIG. 1), thereby causing light leakage.

### SUMMARY OF THE INVENTION

The present disclosure provides a backlight module comprising a bottom chassis, a light source unit, a middle frame, and a front chassis. The bottom chassis includes a plurality of sidewalls that collectively define a receiving space, and a gap is formed between two adjacent ones of the sidewalls. The light source unit is disposed in the receiving space. The middle frame includes at least one positioning boss extending into the gap to restrict the position of the middle frame with respect to the bottom chassis. The front chassis covers the sidewalls and the at least one positioning boss.

Through this configuration, the gap between the sidewalls of the bottom chassis functions as a mounting and positioning structure for the middle frame, while the at least one positioning boss of the middle frame reduces light leakage within the backlight module.

In some embodiments, the bottom chassis further includes a connecting portion connecting the two adjacent sidewalls, and the positioning boss abut the connecting portion.

In some embodiments, a thickness by which the positioning bosses extend outwardly from the bottom chassis is substantially identical to a thickness of the sidewalls.

In some embodiments, the middle frame forms a reflective structure located in the receiving space and disposed on the light source unit.

In some embodiments, the backlight module is a direct-lit backlight module. The reflective structure has a plurality of through holes, and the light source unit includes a light source board and a plurality of light sources arranged in a matrix on the light source board. The plurality of light source pass through the through holes respectively.

In some embodiments, the backlight module further includes an optical stack located between the middle frame and the front chassis.

In some embodiments, the optical stack is surrounded by the sidewalls.

In some embodiments, the positioning bosses have an upper edge surface, the middle frame has an upper surface configured to carry the optical stack, and the upper edge surface of the positioning bosses is higher than the upper surface of the middle frame to cover corners of the optical stack.

In some embodiments, the upper edge surface of the positioning bosses and an upper surface of the optical stack are coplanar.

The present disclosure further provides a display device including the aforementioned backlight module and a display panel disposed above the backlight module.

### BRIEF DESCRIPTION OF THE DRAWINGS

FIG. 1 is a cross-sectional view of a conventional backlight module.

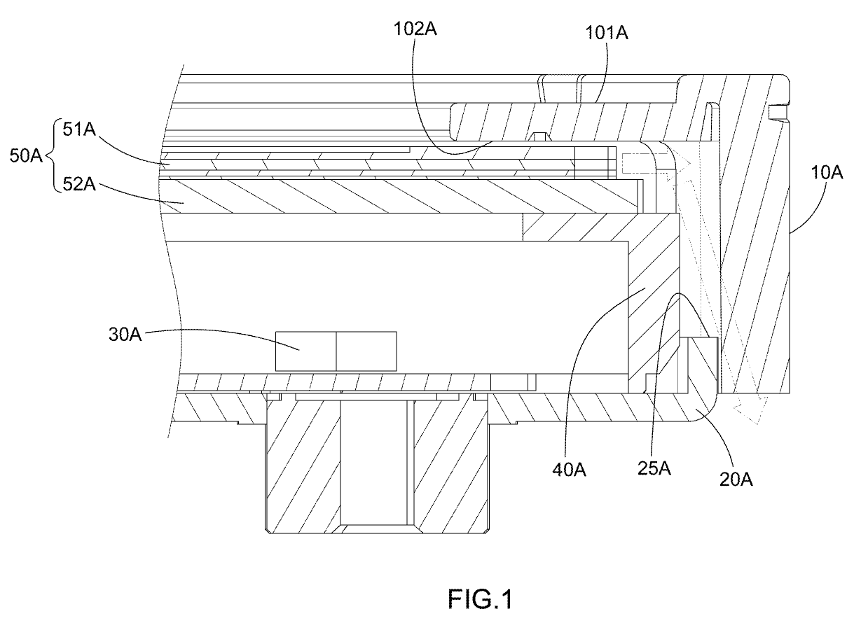

FIG. 2 is an external view of a backlight module.

FIG. 3 is an exploded view illustrating components of a backlight module according to one embodiment.

FIG. 4 is a partially enlarged view of the middle frame and the bottom chassis of the embodiment of FIG. 3.

FIG. 5 is a cross-sectional view of the backlight module of the embodiment of FIG. 3.

FIG. 6 is a partially enlarged view of the middle frame and the bottom chassis according to another embodiment.

FIG. 7 is a cross-sectional view of the backlight module of the embodiment of FIG. 6.

### DETAILED DESCRIPTION OF THE PREFERRED EMBODIMENTS

The directional descriptions provided herein are made with respect to an upward light exit direction of the backlight module, consistent with the conventional understanding of those skilled in the art.

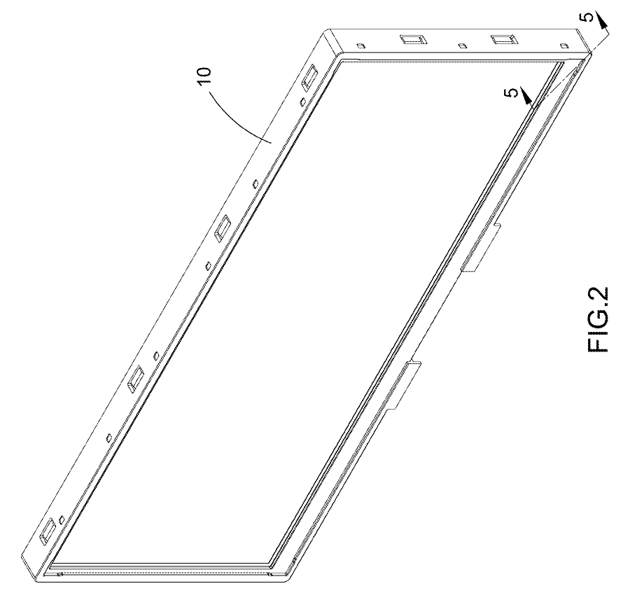

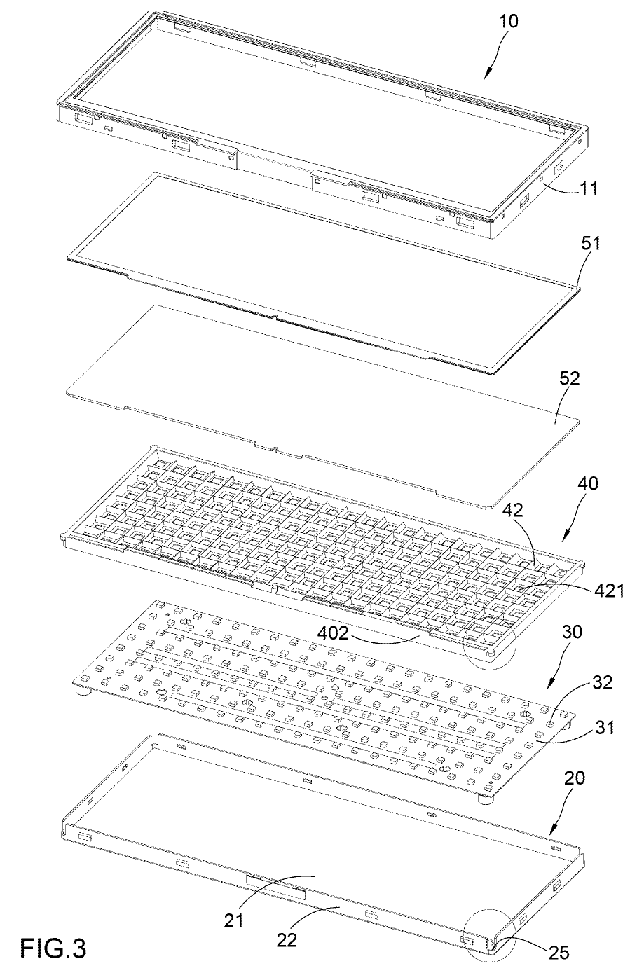

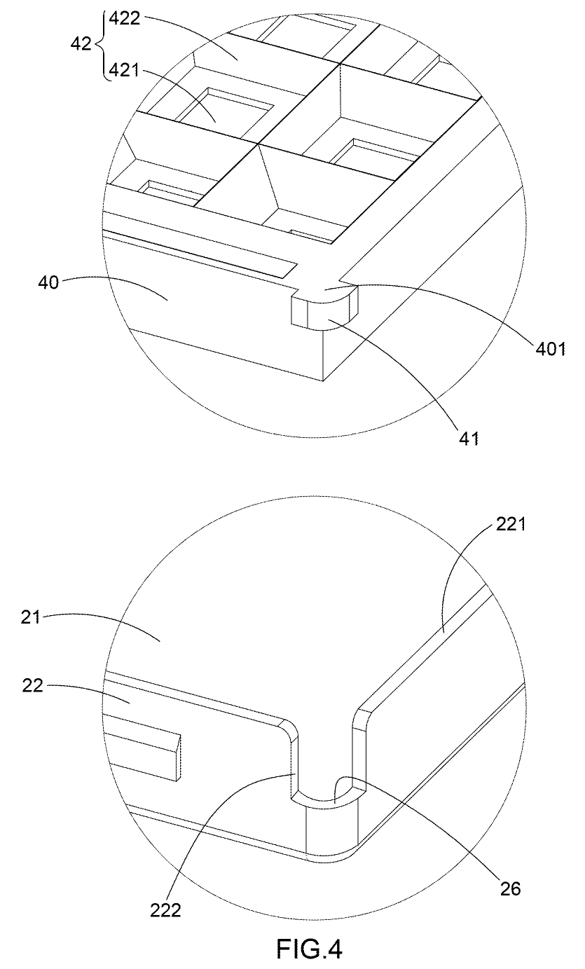

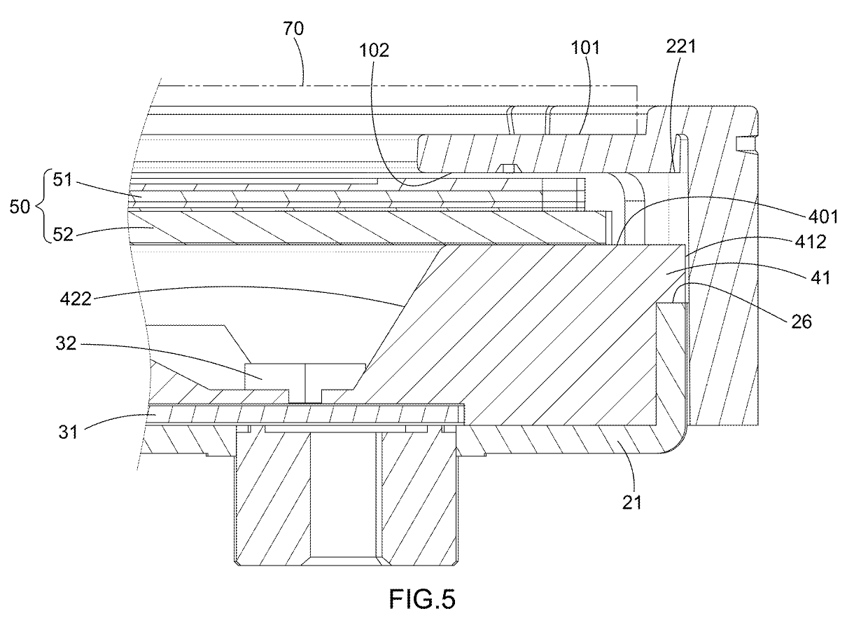

Referring to FIGS. 2 to 5, a backlight module in one embodiment comprises a bottom chassis 20, a light source unit 30, a middle frame 40, and a front chassis 10. The bottom chassis 20 includes a plurality of sidewalls 22 collectively defining a receiving space, and a gap 25 is formed between two adjacent ones of the sidewalls 22. The light source unit 30 is disposed in the receiving space. The middle frame 40 includes at least one positioning boss 41 extending into the gap 25 to restrict the position of the middle frame 40 with respect to the bottom chassis 20. The front chassis 10 covers the sidewalls 22 and the at least one positioning boss 41. The present disclosure utilizes the gap 25 formed by the sidewalls 22 of the bottom chassis 20, positioning and fixing the middle frame 40 on the bottom chassis 20 through the positioning bosses 41. This configuration simplifies the structure of the backlight module, reduces assembly steps and difficulty, and improves assembly efficiency and product reliability. Thus, the gap 25 between the sidewalls 22 of the bottom chassis 20 functions as an installation and positioning structure for the middle frame 40, while the positioning bosses 41 of the middle frame 40 suppress light leakage.

In one embodiment, as shown in FIGS. 2 to 5, the bottom chassis 20 includes a base plate 21 and the plurality of sidewalls 22 connected to the base plate 21. The bottom chassis 20 has two pairs of sidewalls 22 arranged perpendicularly, and the base plate 21 together with the sidewalls 22 defines the receiving space. The middle frame 40 includes a peripheral sidewall 402 extending in the same direction as the sidewalls 22 of the bottom chassis 20. The middle frame 40 is positioned in the receiving space and disposed above the light source unit 30 such that the peripheral sidewall 402 surrounds the light source unit 30.

In one embodiment, as shown in FIGS. 2 to 5, the backlight module further includes an optical stack 50 disposed between the middle frame 40 and the front chassis 10. An upper surface 401 of the middle frame 40 carries the optical stack 50, which may include optical films 51 and a diffusion plate 52, and may further confine the position of the optical stack 50 so that the optical stack 50 is located above the light source unit 30. In another embodiment, the optical stack 50 may also be surrounded by the sidewalls 22, thereby preventing external light interference and providing additional positional confinement.

The front chassis 10 includes a peripheral sidewall 11 and an upper rim. A concave-convex engagement structure is provided between the peripheral sidewall 11 and the sidewalls 22 of the bottom chassis 20, allowing the front chassis 10 to be mounted onto the bottom chassis 20 from above. The upper rim of the front chassis 10 defines an opening, and a boundary of the opening is located above the optical stack 50. In other words, an edge of the optical stack 50 is positioned between a lower surface 102 of the upper rim and the upper surface 401 of the middle frame 40. This arrangement provides a positioning function for the optical stack 50.

In one embodiment, as shown in FIGS. 2 to 5, the middle frame 40 includes at least one positioning boss 41 located at a corner of the peripheral sidewall 402. A position of the positioning bosses 41 corresponds to the gap 25 between two adjacent sidewalls 22 of the bottom chassis 20. When the middle frame 40 is mounted on the bottom chassis 20, the positioning bosses 41 extend toward the gap 25 relative to the peripheral sidewall 402, thereby restricting the position of the middle frame 40 on the bottom chassis 20. The front chassis 10 subsequently covers the sidewalls 22 and the at least one positioning boss 41. Accordingly, the at least one positioning boss 41 not only serves to position the middle frame 40 on the bottom chassis 20, but also blocks internal light from projecting outward through the gap 25.

In one embodiment, as shown in FIGS. 2 to 5, the bottom chassis 20 further includes a connecting portion 26 connecting the two adjacent sidewalls 22, and the positioning bosses 41 abut to be supported by the connecting portion 26. The positioning bosses 41 may also contact a lateral end surface 222 formed by the sidewalls 22 at the location of the gap 25, thereby preventing lateral displacement when the middle frame 40 is assembled onto the bottom chassis 20. Preferably, the connecting portion 26 extends from the base plate 21 and connects the two adjacent sidewalls 22, further enhancing structural stability and avoiding displacement during assembly or use that may adversely affect optical performance.

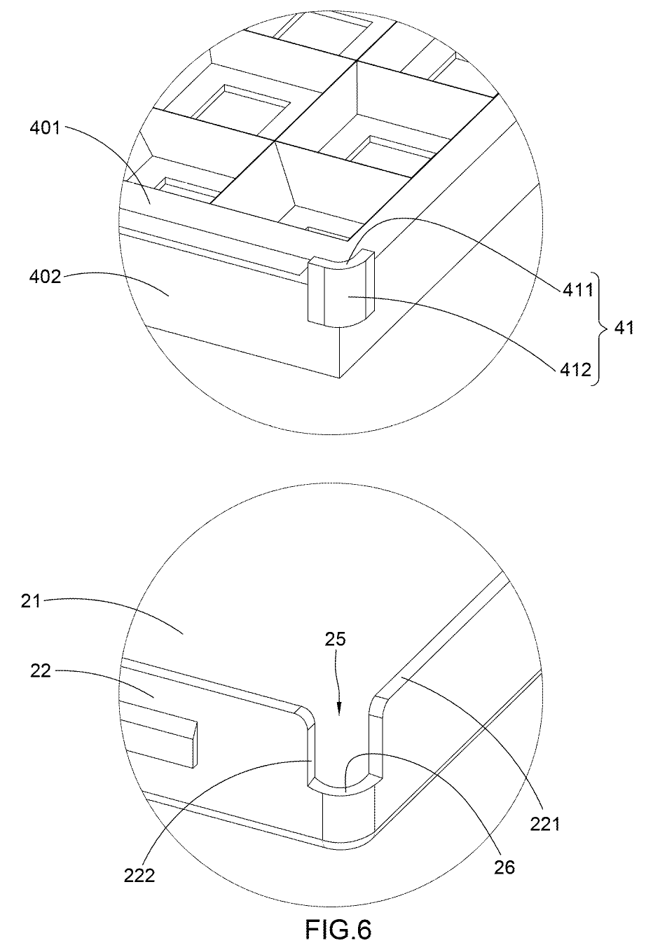

In one embodiment, as shown in FIGS. 2 to 5, a number of the positioning bosses 41 corresponds to a number of the gaps 25, and a thickness by which the positioning bosses 41 extend outward relative to the bottom chassis 20 is substantially equivalent to a thickness of the sidewalls 22. This simplifies manufacturing and reduces material usage. Additionally, by positioning the positioning bosses 41 of the middle frame 40 at the gaps 25 corresponding to corners of the peripheral sidewall 402, a projected contour of the bottom chassis 20 at the connecting portion 26 in a vertical direction can overlap with a projected contour of a curved outer surface 412 of the positioning bosses 41 at the same position (as shown in FIG. 6) when the middle frame 40 is mounted on the bottom chassis 20. Thus, even when an upper surface of the positioning bosses 41 is coplanar with the upper surface 401 of the middle frame 40, light can still be prevented from projecting downward through the gap 25.

In one embodiment, as shown in FIGS. 2 to 5, the light source unit 30 includes a light source board 31 and a plurality of light sources 32 arranged in a matrix on the light source board 31. A bottom of the light source board 31 includes cylinders positioned within circular perforations of the base plate 21 of the bottom chassis 20, and the light source unit 30 is thereby disposed in the receiving space to form a direct-lit backlight module. The matrix arrangement of the plurality of light source 32 ensures uniformity and consistency of emitted light.

In one embodiment, as shown in FIGS. 2 to 5, the middle frame 40 forms a reflective structure 42 located in the receiving space and disposed on the light source unit 30. This configuration enables the direct-lit backlight module to precisely control the propagation direction of emitted light, further improving light-utilization efficiency and preventing multiple internal reflections within the reflective structure 42 that could cause optical interference and degrade optical quality. Through the structural design of the present disclosure, the optical transmission path is effectively controlled, light scattering and interference are reduced, and brightness, uniformity, and color saturation of the displayed image are improved. Preferably, a reflecting surface 422 of the middle frame 40 forms a plurality of conical reflective structures 42. The reflective structure 42 includes a plurality of through holes 421, and the light sources 32 of the light source unit 30 pass through the through holes 421 respectively, such that the reflecting surface 422 of the reflective structure 42 surrounds peripheries of the light source 32. This arrangement facilitates the light projected from the light sources 32 to be reflected and concentrated toward the light exit direction by the reflecting surface 422, reducing scattering and loss and significantly improving light-utilization efficiency. However, in other embodiments, the backlight module may alternatively be an edge-lit backlight module.

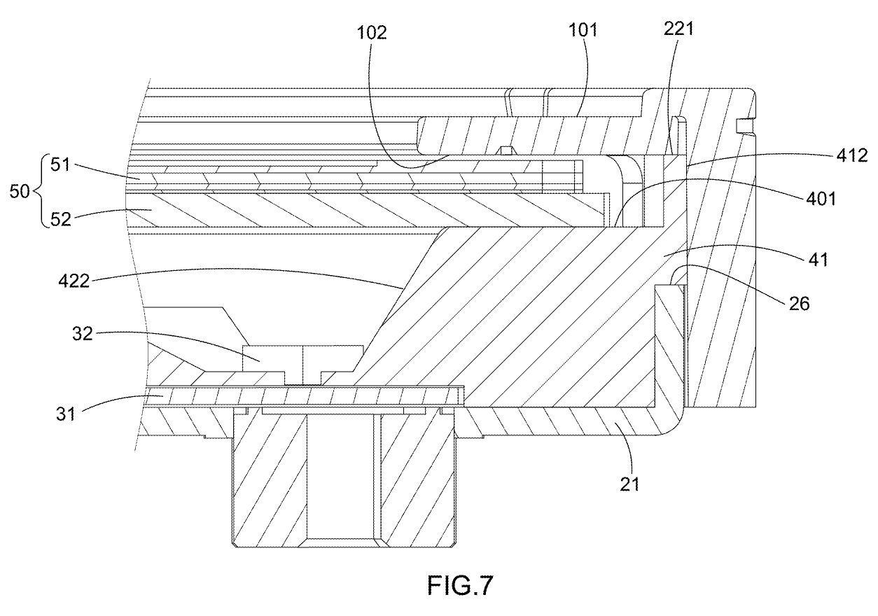

Referring to FIGS. 6 and 7, another embodiment of the backlight module differs from the previous embodiment in that an upper edge surface 411 of the positioning bosses 41 is higher than the upper surface 401 of the middle frame 40, which carries the optical stack 50, enabling the positioning bosses 41 to cover corners of the optical stack 50. Preferably, the positioning bosses 41 have a continuous curved contour and extend upward. Accordingly, the positioning bosses 41 can directly block light emitted laterally from edge surfaces of the optical stack 50 and can further protect the corners of the optical stack 50, preventing damage and ensuring stability of the optical stack 50 to enhance display quality.

In one embodiment, as shown in FIGS. 6 and 7, the upper edge surface 411 of the positioning bosses 41 may be located in the same plane as the upper surface of the optical stack 50, may be flush with an upper end surface 221 of the sidewalls 22, or may be designed to contact the lower surface 102 of the upper rim of the front chassis 10. In addition, a contour of a curved outer surface 412 of the positioning bosses 41 corresponds to a contour of an internal surface of the front chassis 10, thereby directly blocking internal light from entering the gap 25. Furthermore, configuring the upper edge surface 411 of the positioning bosses 41 to be coplanar with the upper surface of the optical stack 50 or higher than the upper surface 401 of the middle frame 40 provides effective protection for corners of the optical stack 50, prevents damage to the optical stack 50, ensures stability of the optical stack 50, and further enhances display quality.

The present disclosure further provides a display device including the aforementioned backlight module and a display panel 70 disposed above the backlight module. The display panel 70 is supported by the upper surface 101 of the upper rim of the front chassis 10. Light emitted from the plurality of light source 32 passes through the optical stack 50 and subsequently illuminates a rear side of the display panel 70 through an opening defined by the upper rim of the front chassis 10. The backlight module of the present disclosure has a simple and compact structural design suitable for display devices of various sizes and specifications, including mobile phones, tablet computers, notebook computers, and other electronic displays. Its superior optical performance and high reliability provide broad application potential and enhance product competitiveness.

In the backlight module disclosed herein, the gap 25 between the sidewalls 22 of the bottom chassis 20 functions as an installation and positioning structure for the middle frame 40, while the positioning bosses 41 of the middle frame 40 suppress light leakage within the backlight module. Additionally, through the simplified structural configuration between the positioning bosses 41 of the middle frame 40 and the sidewalls 22 of the bottom chassis 20, improved structural stability and assembly convenience are achieved, while ensuring optical quality, superior external appearance, and improved yield after reliability and challenge testing.

What is claimed is:

1. A backlight module, comprising:
a bottom chassis having a plurality of sidewalls collectively defining a receiving space, wherein a gap is formed between two adjacent ones of the sidewalls;
a light source unit disposed in the receiving space;
a middle frame having at least one positioning boss extending into the gap to restrict the position of the middle frame with respect to the bottom chassis; and
a front chassis covering the sidewalls and the at least one positioning boss.

2. The backlight module according to claim 1, wherein the bottom chassis further comprises a connecting portion connecting the two adjacent sidewalls, and the at least one positioning boss abuts the connecting portion.

3. The backlight module according to claim 1, wherein a thickness by which the at least one positioning boss extends outward relative to the bottom chassis is substantially equal to a thickness of the sidewalls.

4. The backlight module according to claim 1, wherein the middle frame forms a reflective structure located in the receiving space and disposed on the light source unit.

5. The backlight module according to claim 4, wherein the backlight module is a direct-lit backlight module, the reflective structure has a plurality of through holes, the light source unit includes a light source board and a plurality of light sources arranged in a matrix on the light source board, and the plurality of light sources pass through the through holes respectively.

6. The backlight module according to claim 1, further comprising an optical stack disposed between the middle frame and the front chassis.

7. The backlight module according to claim 6, wherein the optical stack is surrounded by the sidewalls.

8. The backlight module according to claim 6, wherein the at least one positioning boss has an upper edge surface, the middle frame has an upper surface configured to carry the optical stack, and the upper edge surface of the at least one positioning boss is higher than the upper surface of the middle frame to cover corners of the optical stack.

9. The backlight module according to claim 6, wherein an upper edge surface of the at least one positioning boss and an upper surface of the optical stack are coplanar.

10. A display device, comprising:
the backlight module according to claim 1; and
a display panel disposed above the backlight module.
